(19) United States
(12) Patent Application Publication
(10) Pub. No.: US 2016/0216926 A1
(43) Pub. Date: Jul. 28, 2016

(54) IMAGE FORMATION SYSTEM, IMAGE FORMATION DEVICE, AND TERMINAL DEVICE

(71) Applicant: Oki Data Corporation, Tokyo (JP)

(72) Inventor: Tadayuki WATANABE, Tokyo (JP)

(21) Appl. No.: 14/854,582

(22) Filed: Sep. 15, 2015

(30) Foreign Application Priority Data
Jan. 27, 2015 (JP) 2015-013437

(51) Int. Cl. G06F 3/12

(52) U.S. Cl. CPC G06F 3/1292; G06F 3/1205; G06F 3/1231; G06F 3/1232; G06F 3/1294

(57) ABSTRACT

An image formation system that includes: an image formation device configured to form an image on a medium; a terminal device holding image data; a condition setting unit provided to the terminal device and configured to cause a user to set a condition for forming an image on the medium based on the image data; an information exchange unit provided to the terminal device and configured to exchange information with the image formation device by near field communication, the information being necessary for comparison between the condition and a device information piece representing a function possessed by the image formation device; a comparison unit configured to compare the condition with the device information piece; and a comparison result display unit provided to the terminal device and configured to display a comparison result obtained by the comparison unit.

### CROSS REFERENCE TO RELATED APPLICATIONS

This application claims priority based on 35 USC 119 from prior Japanese Patent Application No. 2015-013437 filed on Jan. 27, 2015, entitled “IMAGE FORMATION SYSTEM, IMAGE FORMATION DEVICE, AND TERMINAL DEVICE”, the entire contents of which are incorporated herein by reference.

### BACKGROUND OF THE INVENTION

1. Field of the Invention

This disclosure relates to an image formation system, an image formation device, and a terminal device, which are suitable for use, for example, where an image based on image data held in a terminal device is printed by using an image formation device such as a printer.

2. Description of Related Art

A conventional image formation device is configured to acquire image data, to form a toner image by using an exposure device such as an LED (light emitting diode) head, to transfer the toner image onto a medium such as a paper sheet, to fix the toner image to the paper sheet by using a fixation unit, and thereby to form an image based on the image data on the medium, i.e., to print the image on the paper sheet.

In recent years, there has also been developed an image formation system in which an image formation device is connected to a network to which a personal computer, a server, and the like are connected. In this type of image formation system, the image formation device can print an image based on image data which is supplied from the personal computer through the network, for example.

Furthermore, in some image formation systems, a portable information device (hereinafter referred to as a mobile terminal device) such as a mobile telephone, a smartphone, or a tablet terminal is connected to a network by using a so-called wireless LAN (local area network), and an image based on image data held in the terminal device is printed by using an image formation device.

Two or more image formation devices may be connected to such an image formation system. In some cases, the image formation devices have functions that are different in printable paper sheet size, printable color (color printing or black and white printing), and availability of duplex printing, for example.

For such cases, there is proposed an image formation system configured to allow a user to set desired conditions on a mobile terminal device, to search for image formation devices that match the conditions, to display a search result in an order corresponding to the degree to satisfy the conditions, for example, and to prompt the user to select an image formation device based on the search result (see Japanese Patent Application Publication No. 2005-284938 (FIG. 2), for example).

### SUMMARY OF THE INVENTION

Meanwhile, such a mobile terminal device is generally supposed to be carried around and used in various places by a user. For this reason, when the user is using the terminal device in front of a certain image formation device, the image formation system can allow the user to obtain a printed paper sheet promptly if the image formation system can print the image data by using the certain image formation device.

Nevertheless, the image formation system searches for the image formation devices in accordance with the conditions set by the user, and displays the search result. Accordingly, even if the certain image formation device is installed in front of the user using the mobile terminal device, the image formation system may not display this image formation device in the search result or may display this image formation device at a low rank. In this case, the image formation system may cause the user to select a different image formation device despite the presence of the certain image formation device in front of the user. As a consequence, the image formation system troubles the user to obtain the printed paper sheet by traveling to an installation location of the different image formation device.

An object of an aspect of the invention is to enable an easy formation of an image suitable for conditions desired by a user while reducing the labor to the user of having to go to a more distance image formation device to retrieve the printed image.

An aspect of the invention is an image formation system that includes: an image formation device configured to form an image on a medium; a terminal device holding image data; a condition setting unit provided to the terminal device and configured to cause a user to set a condition for forming an image on the medium based on the image data; an information exchange unit provided to the terminal device and configured to exchange information with the image formation device by near field communication, the information being necessary for making a comparison between the condition and a device information piece that represents a function possessed by the image formation device; a comparison unit configured to compare the condition with the device information piece; and a comparison result display unit provided to the terminal device and configured to display a comparison result obtained by the comparison unit.

According to an aspect of the invention, it is possible to easily form an image suitable for conditions desired by a user while reducing the labor of excessive travel by the user to a more remote image formation device.

### BRIEF DESCRIPTION OF THE DRAWINGS

FIG. 1 is a schematic diagram illustrating a configuration of an image formation system according to a first embodiment.

FIG. 2 is a schematic diagram illustrating configurations of an image formation device and a mobile terminal device according to the first embodiment.

FIG. 3 is a flowchart illustrating a print instruction processing routine by the mobile terminal device according to the first embodiment.

FIG. 4 is a flowchart illustrating a print processing routine by the image formation device according to the first embodiment.

FIGS. 5A to 5D illustrate schematic diagrams of display screens of the mobile terminal device (No. 1).

FIGS. 6A to 6D illustrate schematic diagrams of display screens of the mobile terminal device (No. 2).

FIGS. 7A to 7D illustrate schematic diagrams of display screens of the mobile terminal device (No. 3).

FIGS. 8A to 8C illustrate schematic diagrams of display screens of the mobile terminal device (No. 4).

FIG. 9 is a schematic diagram illustrating a configuration of an image formation system according to a second embodiment.

FIG. 10 is a schematic diagram illustrating configurations of an image formation device and a print server according to the second embodiment.

FIG. 11 is a flowchart illustrating a print processing routine by the image formation device according to the second embodiment.

FIG. 12 is a flowchart illustrating a list of an information generation processing routine by the print server according to the second embodiment.

FIG. 13 is a schematic diagram of a display screen of the mobile terminal device (No. 5).

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### 1. First Embodiment

### 1-1. Configuration of Image Formation System

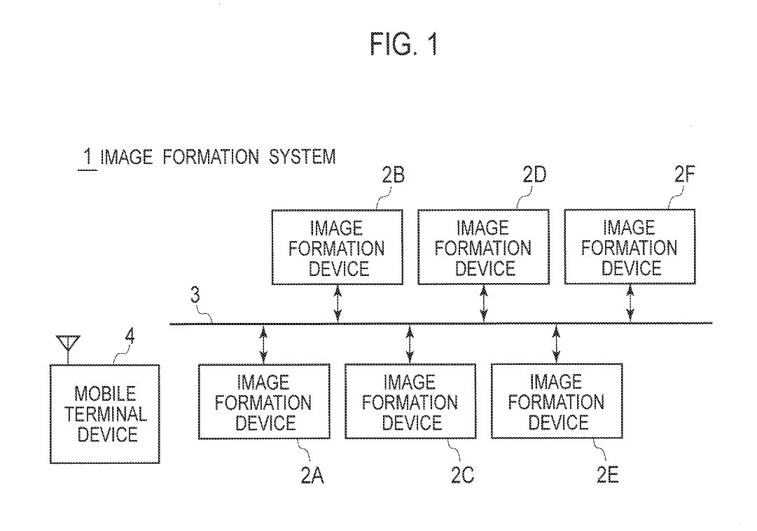

As illustrated in FIG. 1, image formation system 1 of the first embodiment has a configuration in which image formation devices 2A, 2B, 2C, 2D, 2E, and 2F (hereinafter collectively referred to as image formation devices 2), a not-illustrated personal computer, and the like are communicably connected to one another through network 3. It is to be noted that image formation system 1 is installed on two or more floors in a certain company. In addition, “printer A”, “printer B”, “printer C”, “printer D”, “printer E”, and “printer F” are set to image formation devices 2A, 2B, 2C, 2D, 2E, and 2F as node names (names for identifying the devices from one another), respectively.

Network 3 is formed from a wired or wireless LAN (local area network) compliant with standards such as IEEE (Institute of Electrical and Electronics Engineers) 802.3u/ab and IEEE 802.11a/b/g/n.

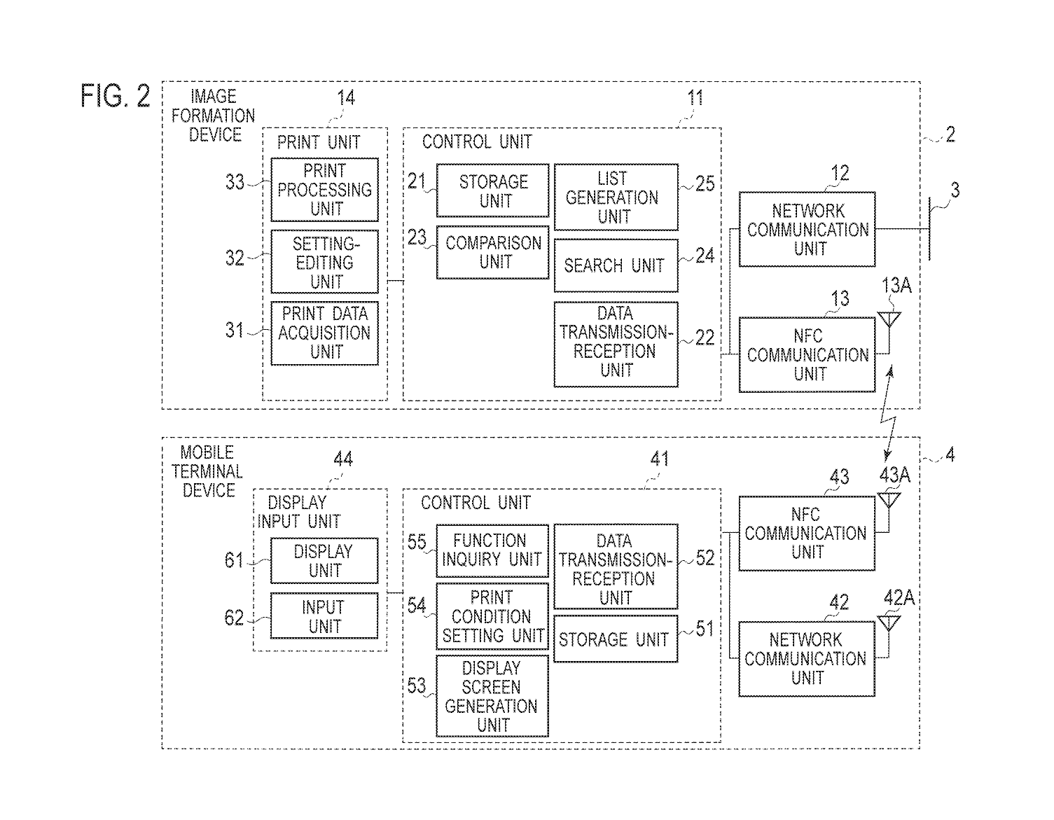

Image formation device 2 is a so-called page printer, which is configured such that an image is formed, i.e., printed on a paper sheet serving as a medium. Image formation device 2 is formed into a rectangular parallelepiped shape having a size large enough for performing print processing while conveying paper sheets in A4 size, A3 size, and the like inside. Image formation devices 2 are installed in predetermined locations in an office of the company, for example. As illustrated in the block diagram of FIG. 2, each image formation device 2 is broadly separated into control unit 11, network communication unit 12, NFC (near field communication) communication unit 13, and print unit 14.

Control unit 11 is mainly formed from a not-illustrated CPU (central processing unit), and is provided with storage unit 21 that includes a ROM (read only memory), a flash memory, a RAM (random access memory), and the like. Control unit 11 performs a variety of processing such as the print processing by reading given programs out of storage unit 21 and executing the programs. In addition, a variety of information such as device information on image formation device 2 or data of various applications is stored in storage unit 21. Here, the device information is information representing functions possessed by image formation device 2 in regard to the image formation as well as conditions of image formation device 2 including, for example, availability of color printing, sizes of paper sheets provided therein, availability of duplex printing, resolution, and the like. Furthermore, the device information also includes location information representing the location where image formation device 2 is installed.

In addition, control unit 11 is configured to execute given programs and thereby to implement functional blocks including data transmission-reception unit 22, comparison unit 23, search unit 24, list generation unit 25, and the like. Data transmission-reception unit 22 transmits or receives various data to and from the outside through network communication unit 12 or NFC communication unit 13. Comparison unit 23, search unit 24, and list generation unit 25 are described later.

Network communication unit 12 is compliant with standards such as IEEE802.3u/ab and is connected to network 3. For example, when data is supplied from data transmission-reception unit 22, network communication unit 12 subjects the data to processing such as packetization, encoding and modulation, and then transmits the resultant data to another device (such as a personal computer or an image formation device) connected to network 3. On the other hand, when data is received from network 3, network communication unit 12 subjects the data to processing such as demodulation, decoding, and depacketization. Thus, network communication unit 12 restores original data and supplies the original data to data transmission-reception unit 22. The data to be treated herein includes, for example, image data representing an image to be printed.

NFC communication unit 13 is compliant with standards such as ISO (International Organization of Standardization)/IEC (International Eletrotechnical Commission) 14443 Type A or Type B, and is configured to perform radio communication with a communication counterpart located a near distance away (in a range from several centimeters to several tens of centimeters, for example) as compared to the distance associated with a wireless LAN and the like. As with network communication unit 12, when the data is supplied from data transmission-reception unit 22, NFC communication unit 13 subjects the data to the processing, such as modulation, and then radiates the resultant data as a radio signal from antenna 13A. On the other hand, when a radio signal is received via antenna 13A, NFC communication unit 13 subjects the radio signal to the processing, such as demodulation, and thereby restores original data. Then, NFC communication unit 13 supplies the original data to data transmission-reception unit 22. Furthermore, NFC communication unit 13 is configured to detect whether or not the communication with the communication counterpart is established, and to notify control unit 11 of a result of the detection.

Meanwhile, antenna 13A is disposed inside image formation device 2 and in the vicinity of an upper surface or a front surface thereof, for example. In addition, a given mark representing that the NFC antenna is built in is provided on an outer peripheral surface of image formation device 2 and in the vicinity of antenna 13A.

Print unit 14 includes print data acquisition unit 31, setting-editing unit 32, and print processing unit 33. Print data acquisition unit 31 acquires print data being data to be printed, as well as print setting information which includes print settings such as a paper sheet size and a selection of color printing or black and white printing, from control unit 11, and supplies the print data and the print setting information to setting-editing unit 32. Setting-editing unit 32 performs an edit processing and the like on the print data based on the acquired print setting information, and supplies the edited print data to print processing unit 33. Print processing unit 33 forms a toner image by using an exposure device such as an LED (light emitting diode) head, transfers the toner image onto a paper sheet, and fixes the toner image to the paper sheet by using a fixation unit, thereby printing the image on the paper sheet based on the print data.

Meanwhile, mobile terminal device 4 (FIG. 1) being a portable information device is included in image formation system 1. Mobile terminal device 4 is formed as a smartphone or a tablet terminal, for example, and has an appropriate size and weight for allowing a user to carry mobile terminal device 4 in one hand easily. Mobile terminal device 4 is formed into a flat rectangular parallelepiped shape or a plate shape and is assumed to be carried to, and used in, various places by the user. Moreover, as illustrated in FIG. 2, mobile terminal device 4 is broadly separated into control unit 41, network communication unit 42, NFC communication unit 43, and display input unit 44.

As with control unit 11 of image formation device 2, control unit 41 is mainly formed from a not-illustrated CPU, and is provided with storage unit 51 that includes a ROM, a flash memory, a RAM, and the like. Control unit 41 performs a variety of processing, such as print instruction processing, by reading given programs out of storage unit 51 and executing the programs. In addition, a variety of information such as image data and data of various applications is stored in storage unit 51.

In addition, control unit 41 is configured to execute given programs and thereby to implement functional blocks including data transmission-reception unit 52, display screen generation unit 53, print condition setting unit 54, function inquiry unit 55, and the like. As with data transmission-reception unit 22, data transmission-reception unit 52 transmits or receives various data to and from the outside through network communication unit 42 or NFC communication unit 43. Display screen generation unit 53, print condition setting unit 54, and function inquiry unit 55 are described later.

Network communication unit 42 is compliant with standards such as IEEE802.11a/b/g/n and is wirelessly connected to a not-illustrated base station and the like, that is, is connected through-the-air. For example, when data is supplied from data transmission-reception unit 52, network communication unit 42 subjects the data to processing such as packetization, encoding, and modulation, and radiates the processed data as a radio signal. On the other hand, when data is received from the base station and the like, network communication unit 42 subjects the data to processing such as demodulation, decoding, and depacketization. Thus, network communication unit 42 restores the original data and supplies the original data to data transmission-reception unit 52. The data to be treated herein includes, for example, image data representing an image to be printed.

Meanwhile, NFC communication unit 43 is formed the same as NFC communication unit 13 of image formation device 2. Note that antenna 43A is disposed at mobile terminal device 4 on an opposite side from display input unit 44, or on a so-called back face side. In addition, as with image formation device 2, a given mark representing that the NFC antenna is built in is provided on an outer peripheral surface of mobile terminal device 4 and in the vicinity of antenna 43A.

Accordingly, by bringing the mark on the back face of mobile terminal device 4 and the mark provided on a housing of image formation device 2 opposed to, or close to, each other, it is possible to bring antenna 43A of NFC communication unit 43 and antenna 13A of NFC communication unit 13 close to each other and thus to establish communication therebetween. The above-mentioned action of bringing the mark provided on mobile terminal device 4 close to the mark provided on the housing of image formation device 2 is hereinafter expressed as “holding one over another”.

Display input unit 44 is disposed on a front face side of mobile terminal device 4 and is formed from a touch panel, which integrates display unit 61 made of an LCD (liquid crystal display) and is configured to display various screens, with input unit 62 formed from a touch sensor and configured to detect an input by a user. Display unit 61 displays screens generated by display screen generation unit 53 of control unit 41. Input unit 62 detects an input operation by the user and notifies control unit 41 of the result of this detection.

### 1-2. Print Processing Originating from Mobile Terminal Device

Next, a case is described in image formation system 1 (FIG. 1) in which the image data held by mobile terminal device 4 is printed by using image formation device 2. Here, as an example, the user who owns mobile terminal device 4 is assumed to be located in the vicinity of image formation device 2A (FIG. 1). For the convenience of description, image formation device 2A is hereinafter also referred to as near distance image formation device 2P while image formation devices 2B to 2F are also referred to as different image formation devices 2Q.

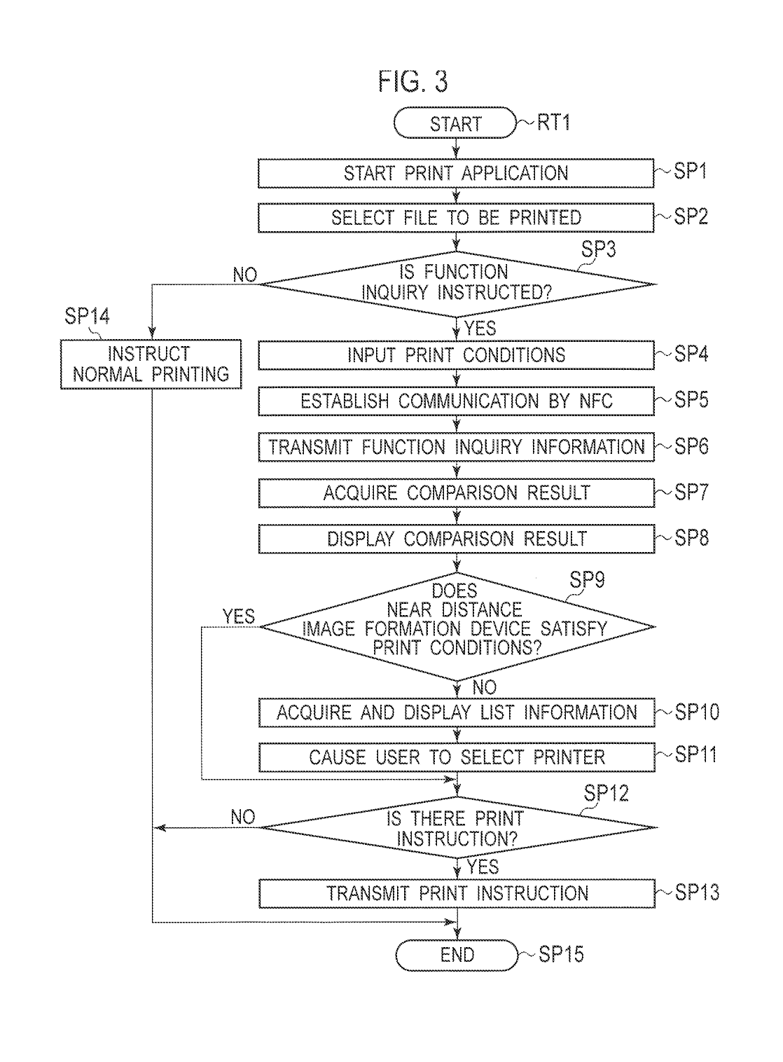

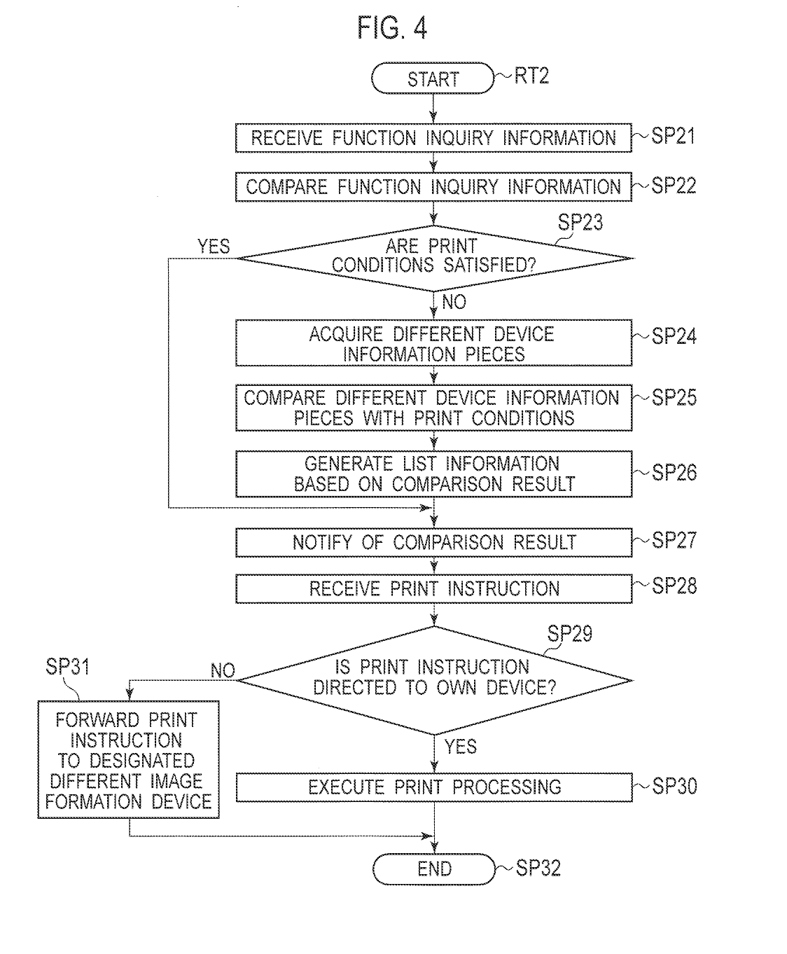

In this case, in image formation system 1, print instruction processing routine RT1 illustrated in FIG. 3 is executed by control unit 41 of mobile terminal device 4, and print processing routine RT2 illustrated in FIG. 4 is executed by control unit 11 of image formation device 2A.

First, control unit 41 of mobile terminal device 4 starts print instruction processing routine RT1 when the user instructs to start a print application through display input unit 44 in the state where a given OS (operating system) is in operation. Then, control unit 41 goes to step SP1. In step SP1, control unit 41 reads a print program for executing the print application out of storage unit 51 and executes the print program. Then, control unit 41 goes to the next step SP2.

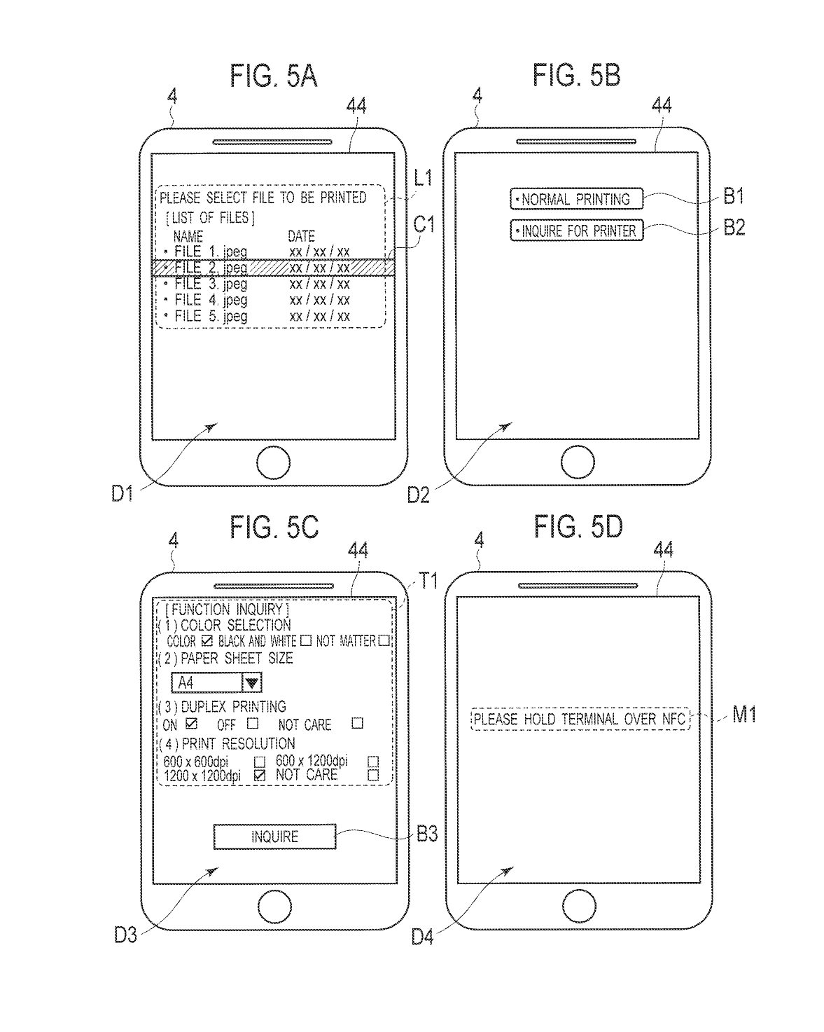

In step SP2, control unit 41 causes display screen generation unit 53 (FIG. 2) to display display screen D1 illustrated in FIG. 5A on display input unit 44. Display screen D1 is formed as a so-called GUI (Graphical User Interface), and file list L1 is arranged therein. File list L1 is a display of image data held in storage unit 51 of mobile terminal device 4 in a list format, in which each row displays one file. Moreover, cursor C1 used for selecting one of the rows in file list L1 is displayed on display screen D1. Cursor C1 displays a background part of characters by using a different color from a color of its surrounding part. Cursor C1 is movable in a vertical direction by a given operation using display input unit 44.

When a given determination operation takes place in a state where cursor C1 is moved on display screen D1, control unit 41 determines that a file on which cursor C1 is located is selected as a file to be printed. Then, control unit 41 goes to the next step SP3. In step SP3, control unit 41 causes display screen generation unit 53 (FIG. 2) to display display screen D2 illustrated in FIG. 5B on display input unit 44.

Display screen D2 displays button B1 indicating “normal printing” and button B2 indicating “inquire for printer”. Each of buttons B1 and B2 can be pressed by the user. Here, “inquire for printer” displayed on button B2 means to instruct a printing of the image data after performing a “function inquiry” in which mobile terminal device 4 inquires of image formation device 2 about functions possessed by image formation device 2, such as printable paper sheet types, availability of color printing, and availability of duplex printing. On the other hand, “normal printing” displayed on button B1 means to instruct image formation device 2 to print the image data immediately without performing the “function inquiry”.

In step SP3, control unit 41 determines whether or not to perform the function inquiry, based on whether button B2 on display screen D2 is pressed or not. When a negative result is obtained here, this means that button B1 is pressed by the user, or in other words, that the user has the intent to give priority to execution of the print processing by use of near distance image formation device 2P located in front of the user. In this case, control unit 41 goes to the next step SP14 to transmit the image data to near distance image formation device 2P, thereby causing near distance image formation device 2P to print the image based on the image data on a paper sheet in accordance with predetermined print settings. Thereafter, control unit 41 goes to the next step SP15 to terminate print instruction processing routine RT1.

On the other hand, when an affirmative result is obtained in step SP3, this means that the user has the intent to execute the print processing by use of image formation device 2 that satisfies the desired conditions without limitation to near distance image formation device 2P located in front of the user. In this case, control unit 41 goes to the next step SP4.

In step SP4, control unit 41 causes display screen generation unit 53 (FIG. 2) to display display screen D3 illustrated in FIG. 5C on display input unit 44. Display screen D3 displays condition input field T1 and button B3 indicating “inquire”. Condition input field T1 is designed as a field for allowing the user to input desired conditions when printing the image data. Specifically, condition input field T1 displays four items, namely, “(1) color selection”, “(2) paper sheet size”, “(3) duplex printing”, and “(4) print resolution”.

The item “(1) color selection” displays options including “color”, “black and white”, and “not care”, and any one of the options can be selected by use of a so-called check box. The item “(2) paper sheet size” is formed as a so-called drop-down list, which allows selection of a certain type of sheet sizes out of multiple sheet sizes including “A4”, “A3”, “A5”, and the like. The item “(3) duplex printing” provides options including “on”, “off”, and “not care”, and any one of the options can be selected by use of a check box. The item “(4) print resolution” provides options including “600×600 dpi”, “600×1200 dpi”, “1200×1200 dpi”, and “not care”, and again any one of the options can be selected by use of a check box.

When button B3 is pressed in the state where the options are selected for the respective items in condition input field T1, control unit 41 causes print condition setting unit 54 to set print conditions based on the selected options, and then goes to the next step SP5. In step SP5, control unit 41 causes display screen generation unit 53 (FIG. 2) to display display screen D4 illustrated in FIG. 5D on display input unit 44. Display screen D4 displays message M1 which is formed from a character string stating “please hold terminal over NFC”. Thus, control unit 41 can encourage the user to move mobile terminal device 4 so as to bring its back face close to the NFC mark on image formation device 2.

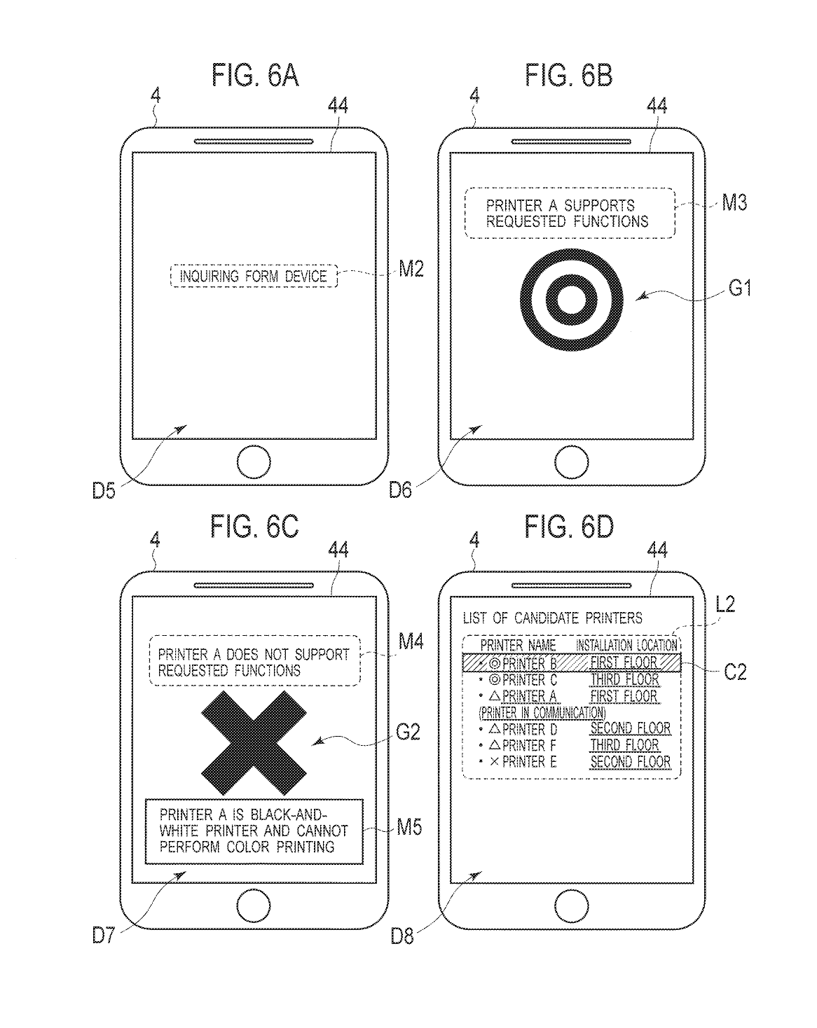

When control unit 41 detects that NFC communication unit 43 establishes the communication with NFC communication unit 13 of image formation device 2A (i.e., near distance image formation device 2P) which is the communication counterpart, control unit 41 causes display input unit 44 to display display screen D5 illustrated in FIG. 6A, and then goes to the next step SP6. In step SP6, control unit 41 transmits the print conditions as function inquiry information to image formation device 2 through NFC communication unit 43, and then goes to the next step SP7.

On the other hand, control unit 11 of image formation device 2A being near distance image formation device 2P monitors the state of communication by NFC communication unit 13 when power is on. When control unit 11 detects that the communication is established between NFC communication unit 13 and the communication counterpart, control unit 11 starts print processing routine RT2 (FIG. 4) and goes to step SP21. In step SP21, control unit 11 receives the print conditions as the function inquiry information from mobile terminal device 4 through NFC communication unit 13, and then goes to the next step SP22.

In step SP22, control unit 11 compares device information on its own (hereinafter referred to as own device information) stored in storage unit 21 with the received print conditions by using comparison unit 23, and then goes to the next step SP23. In step SP23, based on a comparison result, control unit 11 judges whether or not near distance image formation device 2P satisfies the print conditions set by mobile terminal device 4. When an affirmative result is obtained here, this means that the image data in mobile terminal device 4 is supposed to be printed by use of near distance image formation device 2P which is image formation device 2 located closest to the user who owns mobile terminal device 4. In this case, control unit 11 goes to the next step SP27.

On the other hand, when a negative result is obtained in step SP23, this means that although near distance image formation device 2P is unable to perform the print processing in accordance with the print conditions, the print processing in accordance with the print conditions may be executed if one of the different image formation devices 2Q satisfies the print conditions. In this case, control unit 11 goes to the next step SP24.

In step SP24, as search processing, control unit 11 causes search unit 24 to request different image formation devices 2Q connected to network 3 for device information and acquires the device information respectively therefrom. Then, control unit 11 goes to the next step SP25. In step SP25, control unit 11 compares the pieces of device information (hereinafter referred to as different device information pieces) acquired from the respective different image formation devices 2Q with the print conditions, and then control unit 11 goes to the next step SP26. In step SP26, control unit 11 causes list generation unit 25 to generate list information which summarizes a comparison result of the different device information pieces with the print conditions as well as some of the different device information pieces in a list format. Control unit 11 stores the list information in storage unit 21 and then goes to the next step SP27.

In step SP27, control unit 11 transmits a comparison result to image formation device 2 through NFC communication unit 13, and then goes to the next step SP28. Here, the comparison result is information indicating whether or not the own device information satisfies the print conditions, i.e., whether or not near distance image formation device 2P can perform the print processing in accordance with the print conditions.

In response, control unit 41 of mobile terminal device 4 acquires the comparison result through NFC communication unit 43 in step SP7 of print instruction processing routine RT1 (FIG. 3), and then goes to the next step SP8. In step SP8, control unit 41 causes display screen generation unit 53 to generate a screen that displays the comparison result and causes display input unit 44 to display the screen, and then goes to the next step SP9.

At this time, control unit 41 causes display input unit 44 to display either display screen D6 illustrated in FIG. 6B when near distance image formation device 2P satisfies the print conditions, or display screen D7 illustrated in FIG. 6C when near distance image formation device 2P does not satisfy the print conditions. Display screen D6 displays message M3 stating “printer A supports requested functions” as well as “double circle” graphic G1. Thus, display screen D6 makes the user recognize that near distance image formation device 2P satisfies the print conditions.

On the other hand, display screen D7 displays message M4 stating “printer A does not support requested functions”, “cross mark” graphic G2, and message M5 stating “printer A is a black-and-white printer and cannot perform color printing”. Thus, display screen D7 makes the user recognize the fact that near distance image formation device 2P does not satisfy the print conditions, together with the reason for not satisfying the print conditions.

In step SP9, based on the comparison result obtained in step SP7, control unit 41 judges whether or not near distance image formation device 2P satisfies the print conditions. When a negative result is obtained here, this means that there remains a potential that one of the different image formation devices 2Q can perform printing in accordance with the print conditions and it is therefore necessary to set the comparison result before the user so as to cause the user to select image formation device 2 to be used for printing. In this case, control unit 41 goes to the next step SP10.

In step SP10, control unit 41 acquires the list information stored in storage unit 21 of near distance image formation device 2P through NFC communication unit 43, and causes display input unit 44 to display the list information. Then, control unit 41 goes to the next step SP11. At this time, based on the list information, control unit 41 causes display screen generation unit 53 to display display screen D8 illustrated in FIG. 6D on display input unit 44.

Display screen D8 displays the comparison result of the different device information pieces acquired from different image formation devices 2Q with the print conditions, in the form of list L2. List L2 represents the comparison result in a list format, in which near distance image formation device 2P as well as different image formation devices 2Q (i.e., printers) are allocated one by one to rows, and the image formation devices are sorted such that the one with the highest degree of satisfaction of the print conditions comes up on the top.

A printer name such as “printer B” (i.e., a node name), any one of marks out of a double circle mark, a triangle mark, and a cross mark, and an installation location are displayed on each line of list L2. Among them, the marks represent the comparison result. Specifically, the double circle mark means that all the print conditions are satisfied, the triangle mark means that part of the print conditions are satisfied, and the cross mark means that none of the print conditions are satisfied.

On list L2, “printer A” being near distance image formation device 2P is underlined and is also annotated with “(printer in communication)”, thus representing that “printer A” is image formation device 2A now located in front of the user. Moreover, cursor C2 for selecting one of the printers is displayed on list L2. Cursor C2 specifies a certain one of the rows displayed on list L2 by coloring the background thereof. Cursor C2 is movable in a vertical direction by a given operation using display input unit 44.

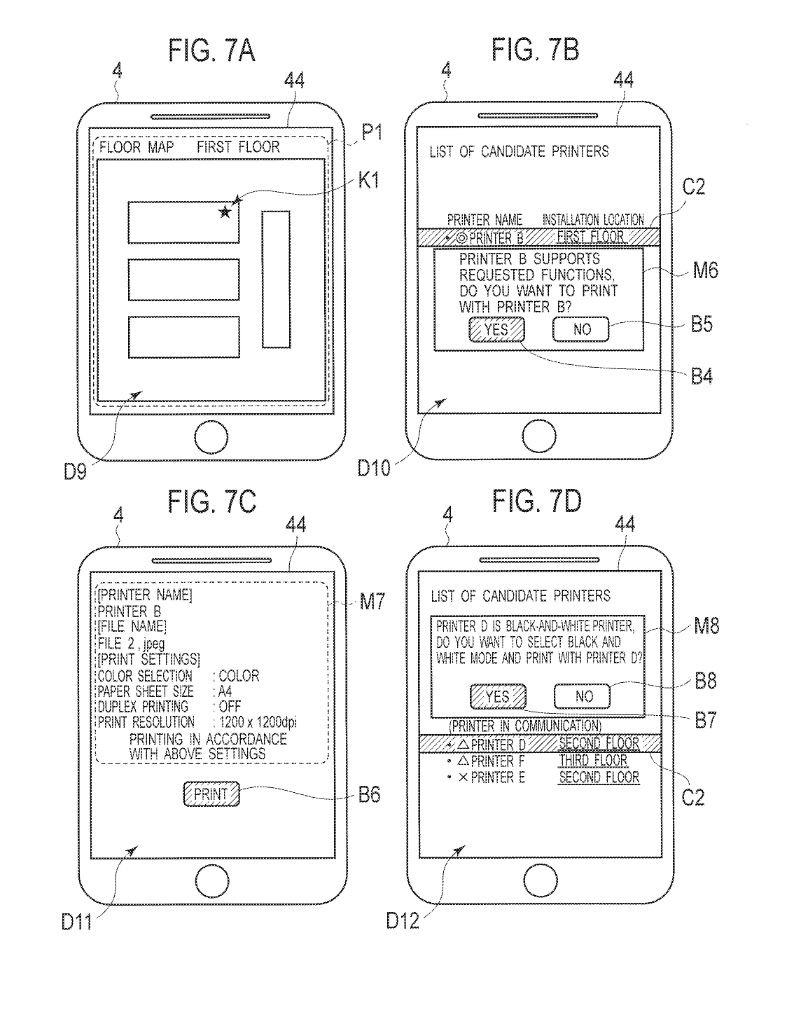

Information on the installation location displayed on list L2 is included in the device information acquired from each image formation device 2. Meanwhile, when an operation such as touching a display position of any installation location is performed, control unit 41 causes display screen generation unit 53 to display display screen D9 illustrated in FIG. 7A on display input unit 44. Display screen D9 displays the installation location of image formation device 2 subjected to the operation, by use of map image P1 and mark K1. Incidentally, the image of this map is stored in each image formation device 2 in advance as location information that constitutes part of the device information, and is acquired as the list information from near distance image formation device 2P.

In step SP11, control unit 41 urges the selection of one of the rows, i.e., one of image formation devices 2 out of list L2 on display screen D8, and then goes to the next step SP12. At this time, when “printer B” satisfying all of the print conditions is selected, for example, control unit 41 causes display input unit 44 to display display screen D10 illustrated in FIG. 7B on display input unit 44. Display screen D10 displays message field M6 which is superposed on display screen D8 (FIG. 6D). Message field M6 displays a message for urging confirmation by stating “Printer B supports required functions, do you want to print with printer B?” together with button B4 indicating “yes” and button B5 indicating “no”.

When button B5 is pressed, control unit 41 returns to display screen D8. On the other hand, when button B4 is pressed, control unit 41 causes display screen generation unit 53 to generate display screen D11 illustrated in FIG. 7C and to display display screen D11 on display input unit 44. Display screen D11 displays message M7, which indicates a file name to be printed, the conditions, and the like in the form of character strings, and button B6 indicating “print”. Here, when button B6 is pressed, control unit 41 goes to the next step SP12.

Meanwhile, when “printer D” that satisfies part of the print conditions is selected on display screen D8 (FIG. 6D), control unit 41 causes display input unit 44 to display display screen D12 illustrated in FIG. 7D. Display screen D12 displays message field M8 which is superposed on display screen D8 (FIG. 6D). Message field M8 displays a message for urging confirmation by stating “Printer D is a black-and-white printer. Do you want to select the black and white mode and print with printer D?” This message is displayed together with button B7 indicating “yes” and button B8 indicating “no”.

When button B8 is pressed, control unit 41 returns to display screen D8. On the other hand, when button B7 is pressed, control unit 41 generates display screen D11 (FIG. 7C) and causes display input unit 44 to display display screen D11. In this case, however, the color selection is indicated as “black and white” in a print setting field in message M7. When button B6 on display screen D11 is pressed, control unit 41 goes to the next step SP12.

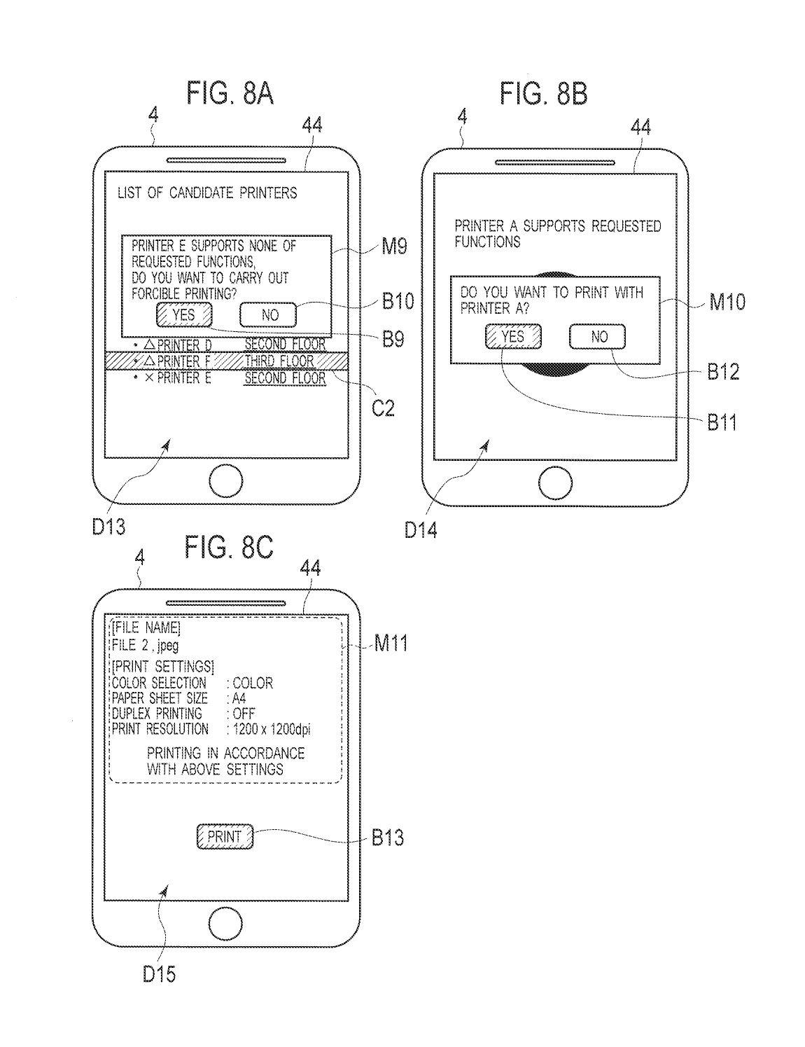

Furthermore, when “printer E” that satisfies none of the print conditions is selected on display screen D8 (FIG. 6D), control unit 41 causes display input unit 44 to display display screen D13 illustrated in FIG. 8A. Display screen D13 displays message field M9 which is superposed on display screen D8 (FIG. 6D). Message field M9 displays a message for urging confirmation by stating “Printer E supports none of the requested functions. Do you want to carry out forcible printing?” This message is displayed together with button B9 indicating “yes” and button B10 indicating “no”.

When button B10 is pressed, control unit 41 returns to display screen D8. On the other hand, when button B9 is pressed, control unit 41 generates display screen D11 (FIG. 7C) and causes display input unit 44 to display display screen D11. In this case, however, the contents of the settings that are in compliance with the functions of printer E are displayed in the print setting field in message M7. When button B6 on display screen D11 is pressed, control unit 41 goes to the next step SP12.

On the other hand, when an affirmative result is obtained in step SP9, control unit 41 causes display screen generation unit 53 (FIG. 2) to generate display screen D14 illustrated in FIG. 8B and to display display screen D14 on display input unit 44. Display screen D14 displays message field M10 which is superposed on display screen D6 (FIG. 6B). Message field M10 displays an inquiry message stating “Do you want to print with printer A?”, together with button B11 indicating “yes” and button B12 indicating “no”. Control unit 41 goes to the next step SP12 when control unit 41 accepts an operation by the user pressing button B11 or B12.

In step SP12, control unit 41 judges whether or not a print instruction is made. Specifically, control unit 41 judges whether or not button B2 on display screen D2 (FIG. 5B) is pressed, button B11 on display screen D14 (FIG. 8B) is pressed, or button B6 on display screen D11 (FIG. 7C) is pressed as the print instruction. When an affirmative result is obtained here, control unit 41 goes to the next step SP13. In step SP13, control unit 41 transmits a print instruction to near distance image formation device 2P by using NFC communication unit 43. Then, control unit 41 goes to the next step SP15 to terminate print instruction processing routine RT1.

In response, control unit 11 of image formation device 2A receives the print instruction from mobile terminal device 4 through NFC communication unit 13 in step SP28 of print processing routine RT2 (FIG. 4), and then goes to the next step SP29. Here, besides the image data, the print instruction includes the node name and the print settings (color or black and white printing, the paper sheet size, the presence of duplex printing, and the like) of image formation device 2 which executes the print processing.

In step SP29, control unit 11 judges whether or not image formation device 2 designated in the print instruction is the image formation device itself, i.e., whether or not image formation device 2 is near distance image formation device 2P. When an affirmative result is obtained here, control unit 11 goes to the next step SP30 and causes print unit 14 (FIG. 2) to print the image data in accordance with the print settings based on the print instruction. Thereafter, control unit 11 goes to the next step SP32 to terminate print processing routine RT2.

On the other hand, when a negative result is obtained in step SP29, control unit 11 goes to the next step SP31. In step SP31, control unit 11 causes network communication unit 12 to forward the image data and the print settings to image formation device 2 designated in the print instruction (i.e., different image formation device 2Q). Thereafter, control unit 11 goes to step SP32 to terminate print processing routine RT2. Thus, different image formation device 2Q, to which the image data and the print settings are forwarded, prints the image data in accordance with the received print settings. In the meantime, the user of mobile terminal device 4 can acquire the paper sheet printed with the image based on the image data by traveling to the location where different image formation device 2Q is installed.

### 1-3. Operation and Effect

In the above-described configuration, image formation system 1 according to the first embodiment causes the user to set the print conditions by using mobile terminal device 4 in the first place, and transmits the print conditions from mobile terminal device 4 to near distance image formation device 2P by using the NFC. Near distance image formation device 2P compares the device information with the print conditions, and transmits the comparison result thus obtained to mobile terminal device 4. In this way, image formation system 1 can notify the user, by way of mobile terminal device 4, of the information as to whether or not near distance image formation device 2P located in front of the user can perform the print processing in accordance with the print conditions.

In other words, based on the assumption that the communication takes place between mobile terminal device 4 and image formation device 2 by the NFC, image formation system 1 deems that mobile terminal device 4 is located near image formation device 2 and the user is also located nearby. Hence, image formation system 1 is configured to notify the user of the comparison result regarding near distance image formation device 2P located in front of the user in the first place, and thereby to reduce as much as possible the labor of the user having to travel to a more distant/remote location in order to obtain the paper sheet after the printing.

Meanwhile, image formation system 1 is configured, when near distance image formation device 2P satisfies the print conditions, to accept the instruction from the user to execute the print processing while selecting near distance image formation device 2P. Accordingly, when near distance image formation device 2P satisfies the print conditions, image formation system 1 can avoid the trouble of having the user select near distance image formation device 2P located in front of the user out of the list while displaying the list of many image formation devices 2 on display input unit 44 of mobile terminal device 4, for example.

In the meantime, image formation system 1 is configured, when near distance image formation device 2P does not satisfy the print conditions, to cause near distance image formation device 2P to generate the list information and to display the list information on display input unit 44 of mobile terminal device 4 as display screen D8 (FIG. 6D). Thus, image formation system 1 can set the device information concerning different image formation devices 2Q connected through network 3 before the user by using mobile terminal device 4 without causing the user to perform an additional operation.

In addition, at this time, image formation system 1 is configured to generate the list information by using near distance image formation device 2P instead of using mobile terminal device 4. For this reason, image formation system 1 can minimize arithmetic processing by mobile terminal device 4 as well as the communication by the NFC, and suppress power consumption by mobile terminal device 4.

Furthermore, on display screen D8, image formation system 1 displays the device information not directly, but in the form of the result of the comparison with the print conditions by using the marks such as the double circle. Thus, image formation system 1 can cause the user to easily recognize which one is image formation device 2 that satisfies the desired print conditions.

In addition, image formation system 1 is configured to display the installation locations alongside the node names of image formation devices 2 on display screen D8. Thus, image formation system 1 can allow the user to comprehend, simultaneously with the comparison result, the labor required for the necessary travel to each image formation device 2 to obtain the printed sheet. Accordingly, the user can select one of image formation devices 2 while taking into account the degree of satisfaction of the print conditions as well as the labor of the travel.

Moreover, when the predetermined operation is performed on display screen D8, image formation system 1 is configured to display display screen D9 (FIG. 7A) so as to illustrate the installation location in the form of a map. Thus, image formation system 1 can allow the user to easily comprehend the location where image formation device 2 is installed.

In addition, image formation system 1 is configured to forward the image data and the print settings from near distance image formation device 2P to different image formation device 2Q through network 3 when the user instructs printing while selecting different image formation device 2Q. Thus, image formation system 1 does not have to trouble the user by causing the user to travel to the location of different image formation device 2Q and to establish the communication anew between mobile terminal device 4 and different image formation device 2Q by the NFC.

According to the above-described configuration, image formation system 1 of the first embodiment causes the user to set the print conditions by using mobile terminal device 4 and transmit the print conditions from mobile terminal device 4 to near distance image formation device 2P by using the NFC so as to compare the print conditions with the device information, and causes near distance image formation device 2P to transmit the comparison result to mobile terminal device 4. Meanwhile, when near distance image formation device 2P does not satisfy the print conditions, image formation system 1 causes near distance image formation device 2P to generate the list information representing the information concerning different image formation devices 2Q and to transmit the list information to mobile terminal device 4. Accordingly, image formation system 1 can preferentially give notice of the availability of the print processing in accordance with the print conditions by near distance image formation device 2P located in front of the user. Meanwhile, when near distance image formation device 2P does not satisfy the print conditions, image formation system 1 can allow the user to recognize the device information on different image formation devices 2Q by the comparison result.

### 2. Second Embodiment

### 2-1. Configuration of Image Formation System

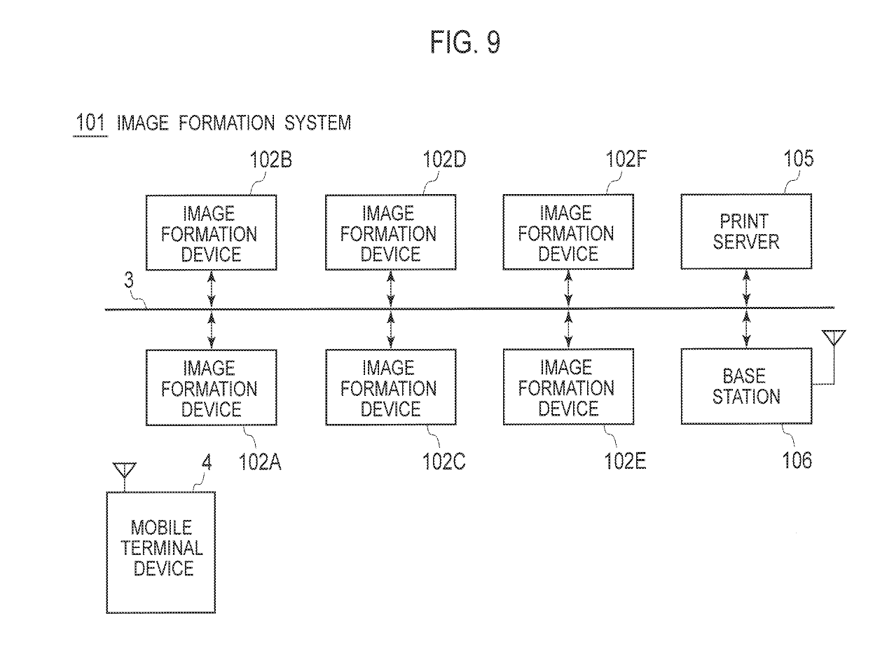

As illustrated in FIG. 9 corresponding to FIG. 1, image formation system 101 according to a second embodiment is different from image formation system 1 according to the first embodiment in that image formation system 101 includes image formation device 102 instead of image formation device 2, and that print server 105 and base station 106 are added thereto. Other features of image formation system 101 are similar to those of image formation system 1.

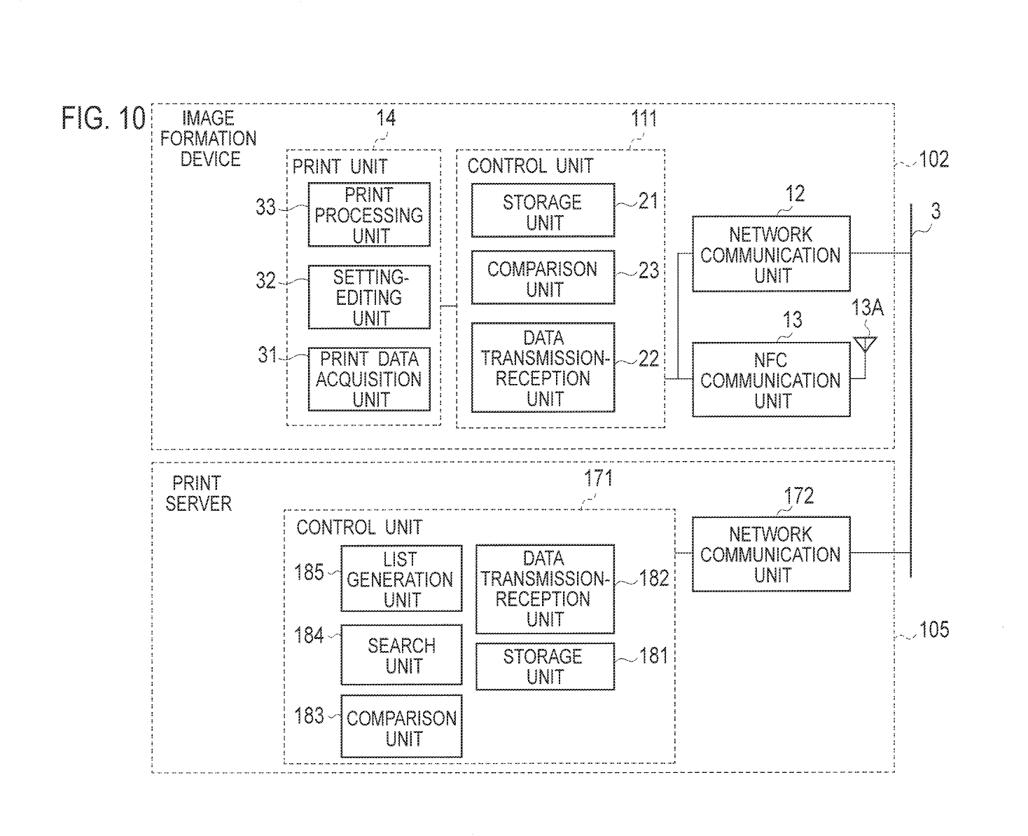

As illustrated in FIG. 10 corresponding to part of FIG. 2, image formation device 102 is different from image formation device 2 according to the first embodiment in that image formation device 102 includes control unit 111 instead of control unit 11. However, other features of image formation device 102 are similar to those of image formation device 2. As compared to control unit 11 of the first embodiment, control unit 111 is different in that search unit 24 and list generation unit 25 are deleted therefrom. However, other features of control unit 111 are similar to those of control unit 11.

As illustrated in FIG. 10, print server 105 is broadly separated into control unit 171 and network communication unit 172. Control unit 171 is mainly formed from a not-illustrated CPU, and is provided with storage unit 181 including a ROM, a flash memory, a RAM, and the like. Control unit 171 performs a variety of processing such as print management processing by reading given programs out of storage unit 181 and executing the programs. In addition, a variety of information such as device information on each image formation device 102 is stored in storage unit 181. Network communication unit 172 is formed in the same way as network communication unit 12 of image formation device 102.

Control unit 171 is configured to execute given programs and thereby to implement functional blocks including data transmission-reception unit 182, comparison unit 183, search unit 184, list generation unit 185, and the like. Data transmission-reception unit 182, comparison unit 183, search unit 184, and list generation unit 185 are formed in the same way as data transmission-reception unit 22, comparison unit 23, search unit 24, and list generation unit 25 implemented in control unit 11 of image formation device 2 of the first embodiment, respectively.

As an intrinsic function, print server 105 is configured to perform total management of image formation devices 102 connected to network 3. For example, when print server 105 receives a print job from a personal computer (not illustrated) connected to network 3, print server 105 temporarily spools the print job, then selects an appropriate image formation device 2, and transmits the print job to image formation device 2 so as to cause image formation device 2 to perform the printing.

### 2-2. Print Processing Originating from Mobile Terminal Device

Next, a case is described in image formation system 101 in which the image data held by mobile terminal device 4 is printed by using image formation device 102. Here, as an example, the user who owns mobile terminal device 4 is assumed to be located in the vicinity of image formation device 102A (FIG. 9). For the convenience of description, as with the first embodiment, image formation device 102A is hereinafter also referred to as near distance image formation device 102P while image formation devices 102B to 102F are also referred to as different image formation devices 102Q.

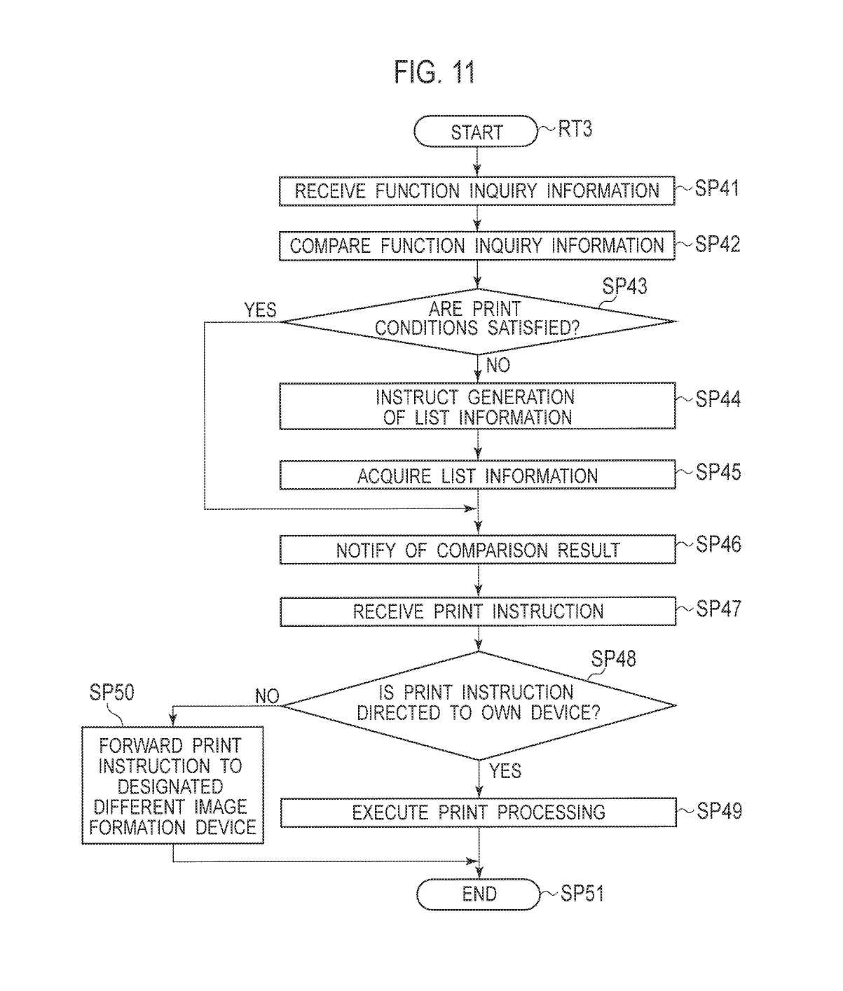

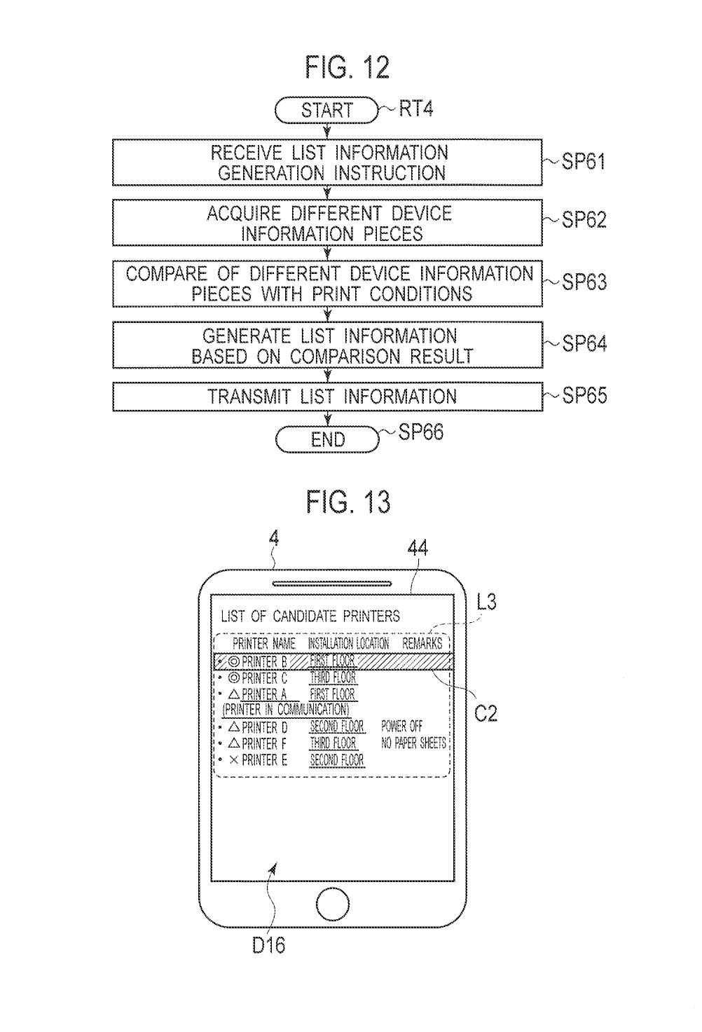

In this case, in image formation system 101, print instruction processing routine RT1 (FIG. 3) is executed by control unit 41 of mobile terminal 4 as with the first embodiment, and print processing routine RT3 illustrated in FIG. 11 is executed by control unit 111 of image formation device 102A. Furthermore, list information generation processing routine RT4 illustrated in FIG. 12 is executed by print server 105.

In steps SP41 to SP43 of print processing routine RT3, control unit 111 of image formation device 102A, which is near distance image formation device 102P, performs processing similar to steps SP21 to SP23 of print processing routine RT2 (FIG. 4), respectively. Control unit 111 goes to step SP44 when a negative result is obtained in step SP43. In step SP44, control unit 111 transmits a list information generation instruction to print server 105 through network 3, and then goes to the next step SP45. Here, the list information generation instruction includes the print conditions received from mobile terminal device 4.

Meanwhile, in step SP61 of list information generation processing routine RT4, control unit 171 of print server 105 receives the list information generation instruction from near distance image formation device 102P through network 3 by using network communication unit 172, and then goes to the next step SP62. Thereafter, in step SP62 to SP64, control unit 171 performs processing similar to steps SP24 to SP26 of print processing routine RT2 (FIG. 4), and goes to the next step SP65.

Here, control unit 171 comprehends the node names and the like of all image formation devices 102 connected to network 3. For this reason, if control unit 171 cannot obtain the device information from a certain image formation device 102, control unit 171 assumes that the certain image formation device 102 is turned off, and includes the assumption in the list information. Meanwhile, if the certain image formation device 102 cannot perform printing due to the fact that paper sheets or toner has run out, control unit 171 includes this fact in the list information as well.

In step SP65, control unit 171 transmits the generated list information to near distance image formation device 102P through network 3 by using network communication unit 172. Then, control unit 171 goes to the next step SP66 to terminate list information generation processing routine RT4.

In response, in step SP45 of print processing routine RT3 (FIG. 11), control unit 111 of near distance image formation device 102P acquires the list information transmitted from print server 105, and then goes to the next step SP46. Thereafter, in steps SP46 to SP50, control unit 111 performs processing similar to steps SP27 to SP31 of print processing routine RT2 (FIG. 4). Then, control unit 111 goes to the next step SP51 to terminate print processing routine RT3.

Nonetheless, in step SP50, control unit 111 once transmits a print instruction to print server 105, and causes print server 105 to transmit the print instruction for the image data and the like to different image formation device 102Q, thereby causing different image formation device 102Q to perform printing.

Meanwhile, in the second embodiment, when the list information is displayed on display input unit 44 of mobile terminal device 4, image screen D16 illustrated in FIG. 13 is displayed instead of display screen D8 (FIG. 6D). Display screen D16 displays list L3 instead of list L2. In addition to “printer name” and “location” columns provided on list L2, display screen D16 is provided with a “remark” column for representing whether or not power is off or whether or not paper sheets or toner has run out. Information such as “power off” or “no paper sheets” is displayed in this column.

### 2.3 Operation and Effect

In the above-described configuration, image formation system 101 according to the second embodiment causes the user to set the print conditions by using mobile terminal device 4 in the first place, and transmits the print conditions from mobile terminal device 4 to near distance image formation device 102P by using the NFC. Near distance image formation device 102P compares the device information with the print conditions, and transmits the comparison result thus obtained to mobile terminal device 4. In this way, as with the first embodiment, image formation system 101 can notify the user, byway of mobile terminal device 4, of the information as to whether or not near distance image formation device 102P located in front of the user can perform the print processing in accordance with the print conditions.

Meanwhile, image formation system 101 is configured, when near distance image formation device 102P does not satisfy the print conditions, to cause print server 105 to generate the list information and to display the list information on display input unit 44 of mobile terminal device 4 in the form of display screen D16 (FIG. 13). Thus, image formation system 101 can set the device information concerning different image formation devices 102Q connected through network 3 before the user by using mobile terminal device 4 without causing the user to perform an additional operation.

Particularly, in the second embodiment, the list information is generated not by near distance image formation device 102P but instead by print server 105 which performs the total management of all image formation devices 102. Accordingly, print server 105 can generate the list information that includes more information based on the functions and performances intrinsically provided to image formation devices 102 as well as the functions and performances available at a certain point in time, and can set the list information thus generated before the user.

Therefore, according to image formation system 101, if the user has a paper sheet to be used for printing while there is certain image formation device 102 that does not temporarily satisfy the print conditions due to a paper sheet shortage though image formation device 102 intrinsically has sufficient performances to satisfy the print conditions, the user can select relevant image formation device 102 and cause image formation device 102 to perform printing. In this case, the user may transmit the image data in advance and then travel to the location of image formation device 102 and execute the print processing after feeding the paper sheet to a paper sheet cassette and the like. In this case, even if image formation device 102 does not face the paper sheet shortage, the user has to travel to the location of image formation device 102 anyway in order to fetch the printed sheet. In this context, there is no additional trouble associated with this travel.

In terms of other features, image formation system 101 can achieve the same operation and effect as that of image formation system 1 of the first embodiment.

According to the above-described configuration, image formation system 101 of the second embodiment causes the user to set the print conditions by using mobile terminal device 4, and to transmit the print conditions from mobile terminal device 4 to near distance image formation device 102P by using the NFC so as to compare the print conditions with the device information. Image formation system 101 causes near distance image formation device 102P to transmit the comparison result to mobile terminal device 4. Meanwhile, when near distance image formation device 102P does not satisfy the print conditions, image formation system 101 causes print server 105 to generate the list information representing the information concerning different image formation devices 102Q and to transmit the list information to mobile terminal device 4. Accordingly, image formation system 101 can preferentially give notice as to the availability of the print processing in accordance with the print conditions by near distance image formation device 102P located in front of the user. Meanwhile, when near distance image formation device 102P does not satisfy the print conditions, image formation system 101 can allow the user to recognize both of the intrinsic device information and the temporary device information on different image formation devices 102Q by using the comparison result.

### 3. Other Embodiments

The above-mentioned first embodiment describes the case of performing the communication of the information directly between mobile terminal device 4 and near distance image formation device 2P by using the NFC while bringing the devices very close to each other. However, the invention is not limited only to this configuration. For example, the devices may communicate with each other by various other communication methods such as infrared communication and communication using a USB cable. What is important in this case is that mobile terminal device 4 and the user are located in the vicinity of near distance image formation device 2P so as to be able to use a communication method that can establish the communication only within a relatively short distance, and the user can easily recognize that the communicating counterpart of mobile terminal device 4 is near distance image formation device 2P. The same applies to the second embodiment.

Meanwhile, the above-mentioned first embodiment describes the case of transmitting the print conditions as the function inquiry information from mobile terminal device 4 to image formation device 2, causing image formation device 2 to perform the comparison processing between the print conditions and the device information, and transmitting the comparison result from image formation device 2 to mobile terminal device 4. However, the invention is not limited only to this configuration. For example, a request for the device information may be transmitted as the function inquiry information from mobile terminal device 4 to image formation device 2. Then in response, the device information may be transmitted from image formation device 2 to mobile terminal device 4, and mobile terminal device 4 may perform the comparison processing between the print conditions and the device information. In this case, the different device information (i.e., the device information on different image formation device 2Q) may be relayed from near distance image formation device 2P to mobile terminal device 4 by using network communication unit 12 and NFC communication unit 13. The same applies to the second embodiment.

Moreover, the above-mentioned first embodiment describes the case in which list L2 of display screen D8 (FIG. 6D) for displaying the list information displays the different device information pieces sorted such that the one with the highest degree of satisfaction of the print conditions comes out on top. However, the invention is not limited only to this configuration. For example, list L2 may display the information pieces sorted in the order of various factors such as, for example, in the order of the proximity to near distance image formation device 2P in terms of the installation location such as the order of the closer floors or the order of the shorter to longer distances, or in the alphabetical order of the printer names. Meanwhile, a sort button for changing the sorting order may be provided in display screen D8. Furthermore, in list L2, near distance image formation device 2P may be fixed to the first row, or alternatively, only different image formation devices 2Q may be displayed while excluding near distance image formation device 2P. The same applies to the second embodiment.

Furthermore, the above-mentioned first embodiment describes the case in which list L2 of display screen D8 (FIG. 6D) for displaying the list information displays the comparison result between the print conditions and the device information for each image formation device 2 by using a mark. However, the invention is not limited only to this configuration. For example, list L2 may display the comparison result by various methods, for example, by providing items of color, paper sheet, duplex printing, resolution, and the like and indicating whether or not the function is satisfied in terms of each of the items by using a “circle mark”, a “cross mark”, and the like. Meanwhile, the degree of satisfaction of the print conditions may be indicated by use of: magnitude of a number; a font color or a background color associated with each printer name; and the like. The same applies to the second embodiment.

In addition, the above-mentioned first embodiment describes the case in which the installation location of the image formation device is displayed on display screen D8 for displaying the list information by use of characters representing the floor, such as “first floor”. However, the invention is not limited only to this configuration. For example, the installation location may be displayed by use of various characters and figures, like a department name such as “sales department”, so that the user can recognize the location. Meanwhile, the information on the installation location does not always have to be stored as the device information by each image formation device. For example, print server 105 according to the second embodiment may be connected to network 3 and only the information on the installation location may be acquired from print server 105. Furthermore, if each printer name (the node name) represents the installation location as in “first floor south side”, for example, then the information on the location does not have to be displayed on display screen D8. On the other hand, the printer name may be omitted instead. The same applies to the second embodiment.

Moreover, the above-mentioned first embodiment describes the case in which display screen D9 (FIG. 7A) displays the map when the pressing operation or the like in order to display the installation location of the image formation device is performed on display screen D8 that displays the list information. However, the invention is not limited only to this configuration. For example, display screen D9 may explain the installation location by various methods including, for example, a character string, an image surrounding image formation device 2, and/or a combination thereof. The same applies to the second embodiment.

Furthermore, the above-mentioned first embodiment describes the case of displaying the information concerning image formation devices 2 on display screen D8 for displaying the list information, by using list L2 in which the character strings are arranged in rows. However, the invention is not limited only to this configuration. The information on image formation devices 2 may be displayed by various methods, for example, by displaying the information pieces on image formation devices 2 with square icons and arranging the icons in a lattice fashion. The same applies to the second embodiment.

In addition, the above-mentioned first embodiment describes the case in which only the device information on any of different image formation devices 2Q successfully received by near distance image formation device 2P is included in the list information. However, the invention is not limited only to this configuration. For example, as with print server 105 in the second embodiment, the device information on all different image formation devices 2Q connected to network 3 may be stored in advance in storage unit 21 as original device information, and the original device information may be included in the list information. In this way, as with the second embodiment, display screen D16 (FIG. 13) can be displayed as the list information. On the other hand, in the second embodiment, print server 105 may generate the list information on the basis of only the device information pieces available from corresponding image formation devices 102.

Moreover, the above-mentioned second embodiment describes the case of displaying the power condition, the fact that the toner is empty, and so forth in the “remark” column on display screen D16 (FIG. 13) for displaying the list information. However, the invention is not limited only to this configuration. For example, the power condition, the fact that the toner is empty and so forth may be displayed by various display methods such as displaying the corresponding printer name or the mark indicating the comparison result in gray. The same applies to the first embodiment.

Furthermore, the above-mentioned second embodiment describes the case in which mobile terminal device 4 transmits and receives various data by using the NFC only. However, the invention is not limited only to this configuration. For example, the data may be transmitted and received by using other communication tools such as a wireless LAN at the same time. To be more precise, when mobile terminal device 4 establishes the communication with, and transmits the inquiry information to, the near distance image formation device 102P by the NFC, it is possible to obtain information necessary for setting the wireless LAN, such as an SSID or security setting information, from near distance image formation device 102P and to perform the setting. Thus, the data can be directly transmitted and received between mobile terminal device 4 and either print server 105 or different image formation device 102Q by the wireless LAN without the intermediary of near distance image formation device 102P. The same effect can be obtained in the first embodiment as well by adding base station 106 to network 3.

Meanwhile, the above-mentioned first embodiment describes the case in which the print conditions include the four items, namely, color or black and white printing, the paper sheet size, the duplex printing, and the resolution. However, the invention is not limited only to this configuration. For example, it is possible to set various other items including the presence of enlargement and reduction functions, a staple function, and a punch function, as well as the presence of a facsimile transmission function, for example. Alternatively, it is also possible to reduce the number of the items so to be equal to or below three items. The same applies to the second embodiment.

Moreover, the above-mentioned first embodiment describes the case of causing the user to select the file to be printed, then causing the user to input the print conditions, and to determine image formation device 2 to execute the print processing. However, the invention is not limited only to this configuration. For example, another configuration may be adopted in which the user is caused to input the print conditions, and then the user is caused to select the file to be printed after determining what image formation device 2 is to execute the print processing.

Furthermore, the above-mentioned first embodiment describes the case of causing the user to select whether or not the function inquiry is performed on display screen D2 (FIG. 5B). However, the invention is not limited only to this configuration. For example, the function inquiry may be performed unconditionally. The same applies to the second embodiment.

In addition, the above-mentioned first embodiment describes the case in which print instruction processing routine RT1 (FIG. 3) is carried out by executing the program stored in advance in storage unit 51 of mobile terminal device 4, and print processing routine RT2 (FIG. 4) is carried out by executing the program stored in advance in storage unit 21 of image formation device 2. However, the invention is not limited only to this configuration. For example, these processing routines may be carried out by installing and executing programs which are supplied from outside through a different information processing device or a detachable storage medium (such as a so-called USB (universal serial bus) memory) connected to network 3. The same applies to the second embodiment.

Moreover, the invention is not limited only to the embodiments or other embodiments mentioned above. Specifically, the invention also encompasses an embodiment which is designed by combining all or part of the above-described embodiments and the above-described other embodiments, and an embodiment which is designed by extracting part of the above-described embodiments and the above-described other embodiments.

Furthermore, the above-mentioned first embodiment describes the case in which the image formation system including image formation device 2 as an image formation device and mobile terminal device 4 as a terminal device is formed from: print condition setting unit 54 as a condition setting unit; function inquiry unit 55 as an information exchange unit; comparison unit 23 as a comparison unit; and list generation unit 25 as well as display screen generation unit 53 collectively as a comparison result display unit. However, the invention is not limited only to this configuration. The image formation system including the image formation device and the terminal device may be formed from the condition setting unit, the information exchange unit, the comparison unit, and the comparison result display unit, which adopt various other configurations, respectively.

The invention is applicable to an image formation system in which image formation devices are connected through a network.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image formation system comprising:
an image formation device configured to form an image on a medium;
a terminal device holding image data;
a condition setting unit provided to the terminal device and configured to cause a user to set a condition for forming an image on the medium based on the image data;
an information exchange unit provided to the terminal device and configured to exchange information with the image formation device by near field communication, the information being necessary for comparison between the condition and a device information piece representing a function possessed by the image formation device;
a comparison unit configured to compare the condition with the device information piece; and
a comparison result display unit provided to the terminal device and configured to display a comparison result obtained by the comparison unit.

2. The image formation system according to claim 1, further comprising:
a near distance image formation instruction unit provided to the terminal device and configured to send the image formation device an instruction to form the image on the medium based on the image data when the comparison unit obtains a comparison result indicating that the device information piece satisfies the condition.

3. The image formation system according to claim 1, wherein
the image formation system comprises two or more of the image formation devices including a near distance image formation device which exchanges the information by the near field communication, and one or more different image formation devices other than the near distance image formation device, the near distance image formation device and the different image formation devices being connected to each other through a network,
the image formation system further comprises a different device information acquisition unit configured to acquire different device information pieces held by the different image formation devices,
the comparison unit compares the condition with the different device information pieces, and
the comparison result display unit displays a comparison result obtained by the comparison unit between the condition and the different device information pieces when the comparison unit obtains a comparison result indicating that the device information piece does not satisfy the condition.

4. The image formation system according to claim 3, wherein the comparison result display unit displays a comparison result between the condition and the different device information pieces for the different image formation devices while sorting data in the comparison result in a predetermined order.

5. The image formation system according to claim 3, wherein the comparison result display unit displays a matching score representing a matching degree of the condition with each of the different device information pieces as the comparison result.

6. The image formation system according to claim 5, wherein the comparison result display unit displays the matching scores for the different image formation devices in an order corresponding to the matching degrees of the condition with the different device information pieces.

7. The image formation system according to claim 3, wherein
the different device information acquisition unit acquires location information pieces representing installation locations of the different image formation devices, in addition to the different device information pieces, and
the comparison result display unit displays, as the comparison result, the installation locations of the different image formation devices based on the location information pieces.

8. The image formation system according to claim 7, wherein the comparison result display unit displays the comparison result for each different image formation device in an order corresponding to a proximity of the installation locations of the different image formation devices to an installation location of the near distance image formation device.

9. The image formation system according to claim 7, wherein the comparison result display unit displays the installation locations of the different image formation devices by using a map.

10. The image formation system according to claim 3, further comprising:
an image formation instruction unit provided to the terminal device and configured to send the near distance image formation device an instruction to form the image on the medium based on the image data when the user selects any of the different image formation devices based on the comparison result displayed by the comparison result display unit; and
an instruction forwarding unit provided to the near distance image formation device and configured to forward the instruction received from the terminal device to the selected different image formation device through the network.

11. The image formation system according to claim 1, wherein
the information exchange unit acquires the device information piece from the image formation device, and
the comparison unit is provided to the terminal device and is configured to compare the condition with the device information piece acquired by the information exchange unit.

12. The image formation system according to claim 1, wherein
the information exchange unit sends the image formation device condition information representing the condition, and
the comparison unit is provided to the image formation device and is configured to compare the condition information with the device information piece and to transmit a comparison result to the terminal device.

13. An image formation device comprising:
an image formation unit configured to form an image on a medium;
a near field communication unit configured to exchange information by near field communication with a terminal device holding image data;
a condition acquisition unit configured to acquire a condition which is set in the terminal device for forming an image on the medium based on the image data;
a comparison unit configured to compare the condition with a device information piece representing a function possessed for formation of the image by the image formation device; and
a comparison result transmission unit configured to transmit a comparison result obtained by the comparison unit to the terminal device by the near field communication, and thus to cause a display unit of the terminal device to display the comparison result.

14. A terminal device comprising:
a storage unit configured to store image data;
a near field communication unit configured to exchange information by near field communication with an image formation device configured to form an image on a medium;
a condition setting unit configured to allow a user to set a condition for forming an image on the medium based on the image data;
a condition transmission unit configured to transmit the condition to the image formation device by the near field communication;
a comparison result acquisition unit configured to acquire a comparison result by the near field communication, the comparison result representing a result of comparison which the image formation device makes between the condition and a device information piece representing a function possessed by the image formation device; and
a display unit configured to display the comparison result acquired by the comparison result acquisition unit.
